(19) United States
(12) Patent Application Publication
(10) Pub. No.: US 2006/0280091 A1
(43) Pub. Date: Dec. 14, 2006

(54) Information recording medium including a predetermined pattern for detecting and RF signal, a method of determining an optimal recording condition using the predetermined pattern, and a recording and/or reproducing apparatus using the information recording medium

(75) Inventors: Hyun-ki Kim, Hwaseong-si (KR); Joo-ho Kim, Yongin-si (KR); Chong-sam Chung, Hwaseong-si (KR); Kyung-geun Lee, Yongin-si (KR); Chang-min Park, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/450,397

(22) Filed: Jun. 12, 2006

(30) Foreign Application Priority Data
Jun. 13, 2005 (KR) 2005-50626
Nov. 14, 2005 (KR) 2005-108730

(51) Int. Cl. G11B 5/09

(52) U.S. Cl. 369/59.18

(57) ABSTRACT

An information recording medium for use with a recording/reproducing apparatus that records/reproduces information to/from the information recording medium on which a predetermined pattern is recorded to generate a predetermined pattern signal with periodically repeating nT pulses and intervening mT pulses to allow for a detection of levels of an RF signal when the recording/reproducing apparatus reads the information from the information recording medium, where n denotes a natural number, T denotes a clock period, and m denotes values corresponding to the respective levels of the RF signal.

### CROSS-REFERENCE TO RELATED PATENT APPLICATIONS

This application claims the benefit of Korean Patent Application No. 2005-50626, filed Jun. 13, 2005, and Korean Patent Application No. 2005-108730, filed Nov. 14, 2005, in the Korean Intellectual Property Office, the disclosures of which are incorporated herein by reference.

### BACKGROUND OF THE INVENTION

1. Field of the Invention

Aspects of the present invention relate to data recording optimization for an information recording medium, and, more particularly, to an information recording medium to generate a predetermined pattern signal to allow for a stable detection of an RF signal level without inter symbolic interference (ISI), a method of determining an optimal recording condition using the predetermined pattern signal, and a recording and/or reproducing apparatus using the information recording medium. Specifically, the present invention may be applicable to an information recording medium, i.e., a super-resolution recording medium, in which data is recorded using marks or spaces having a size smaller than a resolving power of the recording and/or reproducing apparatus that records/reproduces information to/from the information recording medium.

2. Description of the Related Art

Light that is reflected from an optical disk is converted into an electrical signal, and the electrical signal is reproduced in the form of binary data through signal processing. The electrical signal converted from the reflected light is called an RF (radio frequency) signal. Although a binary signal is recorded on the optical disk, the RF signal obtained from the optical disk is an analog signal due to optical disk characteristics and optical recording characteristics. Thus, binary data are obtained from the RF signal through binarization. In the binarization operation, a level of a detected RF signal is compared with a predetermined reference level to obtain binary data. Here, the RF signal is reproduced according to marks or spaces of various lengths recorded on the optical disk, and the level of the RF signal must be precisely detected to obtain reliable binary data.

FIGS. 1A and 1B are graphs respectively showing an eye-pattern simulation result and an eye-pattern experimental result for the case where predetermined data recorded on an information recording medium using marks and spaces that are larger than the resolving power of the recording and/or reproducing apparatus that records and/or reproduces information to and/or from the information recording medium is reproduced according to the related art.

Referring to FIGS. 1A and 1B, since a conventional information recording medium includes marks or spaces that are larger than the resolving power of the recording/reproducing apparatus that records/reproduces information to/from the information recording medium, inter symbolic interference (ISI) occurs less often, and the level of an RF signal corresponding to the length of each mark or space is constant even when the marks or spaces are formed according to a random pattern signal. Therefore, the levels of the RF signal corresponding to the marks or spaces may be distinguished. That is, RF signal levels corresponding to respective marks or spaces may be detected from a clear eye-pattern.

Meanwhile, to increase the recording density of a recording medium, a track pitch is narrowed or the shortest length of a pit is shortened in the recording medium. For example, when a light source that emits light with a wavelength A and an object lens with a numerical aperture NA are used for reproducing data recorded on an information recording medium, even a mark or space having a size smaller than a conventional resolving power limit λ/(4NA) of the medium may be detected in a newly introduced super-resolution recording medium.

In the super-resolution recording medium, the temperature distribution or optical characteristics vary due to the non-uniform optical intensity of a light spot formed on a super-resolution layer. Thus, data recording using marks smaller than the resolving power limit of the recording and/or reproducing apparatus that records/reproduces information to/from the information recording medium may be reproduced.

FIGS. 2A and 2B are graphs respectively showing an eye-pattern simulation result and an eye-pattern experimental result for the case when an RF signal is reproduced from a random pattern recorded on a super-resolution recording medium having marks smaller than the resolving power of the recording and/or reproducing apparatus that records and/or reproduces information to and/or from the information recording medium according to the related art. As shown in FIGS. 2A and 2B, since the super-resolution recording medium has shortened marks in order to obtain a higher recording density, a plurality of marks are covered by an optical spot formed by a laser beam. Thus, an RF signal is affected by the neighboring marks. That is, an RF signal level of a certain mark is affected by RF signal levels of marks positioned before and after the certain mark. Therefore, the RF signal levels are not identical for marks or spaces with the same length since the RF signal varies according to the lengths of neighboring marks. For this reason, it is difficult to detect a precise eye-pattern. As described above, it is difficult to distinguish RF levels of marks or spaces smaller than the resolving power of the recording and/or reproducing apparatus that records/reproduces information to/from the information recording medium in the related art. Further, when recording data on the information recording medium, it is difficult to determine a precise recording condition due to the difficulty of detecting the RF signal level.

### SUMMARY OF THE INVENTION

An aspect of the present invention provides an information recording medium including a predetermined pattern to generate a predetermined pattern signal to allow for a reliable detection of an RF signal. An aspect of the present invention also provides a method of determining an optimal recording condition for the information recording medium by determining the relationship between an RF signal obtained from the predetermined pattern signal and an RF signal obtained from a random pattern signal, and a recording and/or reproducing apparatus using the information recording medium.

According to an aspect of the present invention, there is provided an information recording medium for use with a recording apparatus that records information to the information recording medium on which a predetermined pattern is recorded to generate a predetermined pattern signal with periodically repeating nT pulses and intervening mT pulses to allow for a detection of levels of an RF signal when the recording apparatus reads the information from the information recording medium, where n denotes a natural number, T denotes a clock period, and m denotes values corresponding to the respective levels of the RF signal.

According to another aspect of the present invention, there is provided a method of operating a recording apparatus to determine an optimal recording condition of an information recording medium, comprising recording a predetermined pattern on the information recording medium while changing a recording condition, the predetermined pattern being configured such that a predetermined pattern signal generated from a reading of the predetermined pattern includes periodically repeating nT pulses and intervening mT pulses, where n denotes a natural number, T denotes a clock period, and m denotes values corresponding to respective levels of an RF signal to be detected using the predetermined pattern signal, detecting the levels of the RF signal corresponding to the predetermined pattern signal, and when the detected levels of the RF signal satisfy a predetermined reference condition, setting a corresponding recording condition as the optimal recording condition.

According to a further another aspect of the present invention, there is provided a recording apparatus to record information to an information recording medium, comprising a pick-up unit to record a predetermined pattern on the information recording medium while changing a recording condition, the predetermined pattern being configured to generate a predetermined pattern signal being including periodically repeating nT pulses and intervening mT pulses, where n denotes a natural number, T denotes a clock period, and m denotes values corresponding to respective levels of an RF signal to be detected using the predetermined pattern signal, a detecting unit to detect the levels of the RF signal corresponding to the predetermined pattern signal, the RF signal being read from the information recording medium, and a control unit to determine a corresponding recording condition as the optimal recording condition when the detected levels of the RF signal satisfy a predetermined reference condition.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are graphs respectively showing an eye-pattern simulation result and an eye-pattern experimental result for the case where predetermined data recorded on an information recording medium using marks and spaces larger than the resolving power of the recording and/or reproducing apparatus that records/reproduces information to/from the information recording medium is reproduced according to the related art;

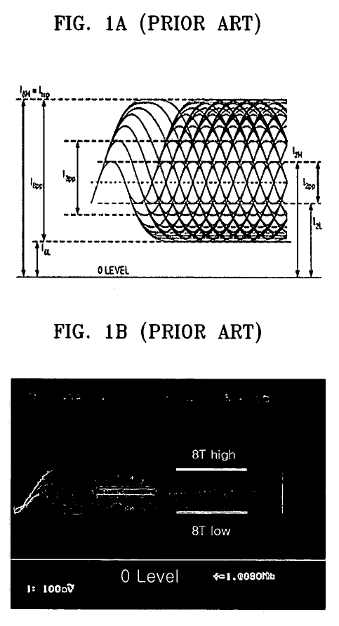

FIGS. 2A and 2B are graphs respectively showing an eye-pattern simulation result and an eye-pattern experimental result for the case where when an RF signal is reproduced from a random pattern recorded on a super-resolution recording medium by using marks smaller than the resolving power according to the related art;

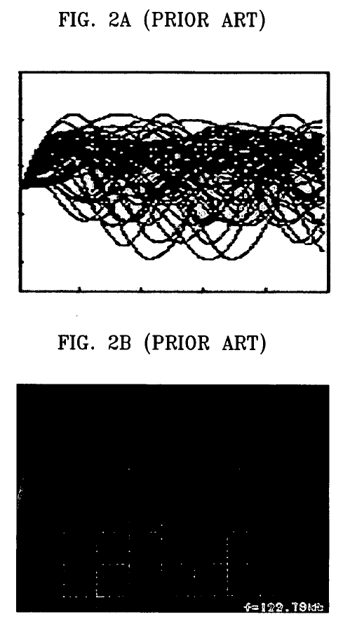

FIG. 3 shows characteristics of RF signals that are respectively measured from a predetermined pattern and a random pattern formed on an information recording medium according to an embodiment of the present invention;

FIGS. 4 and 5 show simulation results obtained based on the conditions of FIG. 3;

FIG. 6 is a graph showing an RF signal waveform detected using a predetermined pattern according to an embodiment of the present invention;

FIG. 7 is a graph showing a phase loop lock (PLL) signal prior to equalization (EQ) in an information recording medium with a predetermined pattern according to an embodiment of the present invention;

FIGS. 8 and 9 are graphs showing RF signal waveforms detected using predetermined patterns formed on an information recording medium according an embodiment of to the present invention;

FIG. 10 are graphs showing RF signals detected using predetermined patterns and random patterns recorded on an information recording medium while varying a recording power of a recording and/or reproducing apparatus according to an embodiment of the present invention;

FIGS. 11A through 12C are graphs showing RF signals obtained using predetermined patterns and random patterns for comparing the RF signals in the same recording condition according to an embodiment of the present invention;

FIG. 13 is a graph showing RF signal waveforms detected from random patterns recorded under the conditions of a 44-mm radius and a 65-mw recording power, and under the conditions of a 41-mm radius and 35-mw recording power, from among the conditions in FIG. 10;

FIGS. 14A and 14B are graph showing RF signals detected from predetermined patterns recorded under the conditions of a 44-mm radius and a 65-mw recording power, and under the conditions of a 41-mm radius and 35-mw recording power according to an embodiment of the present invention;

FIG. 15 shows experimental results of bit error rates (BER) according to asymmetries of predetermined patterns according to an embodiment of the present invention;

FIG. 16 is a graph showing BER with respect to asymmetry and 2T modulation in predetermined patterns according to an embodiment of the present invention;

FIG. 17 is a flowchart of a method of determining an optimal recording condition according to an embodiment of the present invention;

FIG. 18 shows a configuration of an information recording medium according to an embodiment of the present invention; and

FIG. 19 is a block diagram of a recording and/or reproducing apparatus using an information recording medium according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to an embodiment of the present invention, a predetermined pattern to generate a predetermined pattern signal that may be stably detected without inter symbolic interference (ISI) is recorded on an information recording medium, and RF (radio frequency) signal levels corresponding to marks or spaces having various lengths are detected using the predetermined pattern signal. The detected RF signal level is used for random pattern RF signal level detection. Further, according to another embodiment of the present invention, a characteristic similarity between RF signals respectively obtained from the predetermined pattern signal and a random pattern signal generated by a random pattern are each used to determine a recording condition to record the predetermined pattern on an information recording medium in accordance with a predetermined reference condition, the recording condition being used for recording arbitrary data.

First, the relationship between RF signals detected using a predetermined pattern signal and a random pattern signal that are recorded on an information recording medium will be described with reference to simulation and experimental results, according to the present invention.

Hereinbelow, the term “predetermined pattern” refers to a specific pattern that is designed to be relatively stably detected without ISI for use in an information recording medium and a method of determining an optimal recording condition. The term “random pattern” refers to an arbitrary data pattern formed on the information recording medium according to a 1-7

Phase Locked Loop (PLL) Code.

Specifically, the predetermined pattern signal may be configured with periodically repeating nT pulses and mT pulses intervening between the nT pulses, where n denotes a natural number, T denotes a clock period, and m denotes values corresponding to respective levels of an RF signal to be detected using the predetermined pattern.

The predetermined pattern signal may be recorded on an information recording medium using one of a ROM pit, a pre-recorded mark, and a wobble. Further, nT may be smaller than the resolving power of the recording and/or reproducing apparatus that records and/or reproduces information to and/or from the information recording medium, and mT may be equal to or larger than the resolving power of the recording and/or reproducing apparatus that records and/or reproduces information to and/or from the information recording medium.

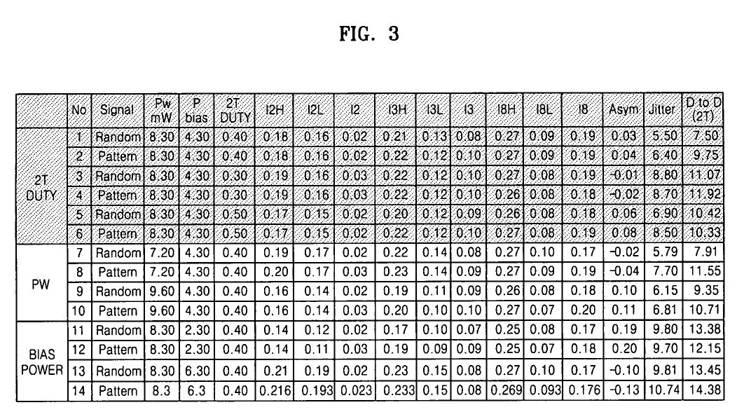

FIG. 3 shows characteristics of RF signals that are respectively measured from a predetermined pattern and a random pattern formed on an information recording medium according to an embodiment of the present invention. Here, a blu-ray disk is used as the information recording medium although other optical disks and, particularly, other high definition optical disks, such as HD-DVDs, may be used. Further, the predetermined pattern signal is configured with 2T as nT, and 2T, 3T, 4T, 5T, 6T, 7T as mT.

As an example, the predetermined pattern signal may be configured as follows: “2T-2T-2T-2T-2T-2T-2T-2T-2T-2T-2T-2T-2T-2T-2T-2T-2T-2T-2T-2T-3T-3T-3T-3T-3T-3T-3T-3T-3T-3T-2T-2T-2T-2T-2T-2T-2T-2T-2T-2T-2T-2T-2T-2T-2T-2T-2T-2T-2T-2T-4T-4T-4T-4T-4T-4T-4T-4T-4T-4T-2T-2T-2T-2T-2T-2T-2T-2T-2T-2T-2T-2T-2T-2T-2T-2T-2T-2T-2T-2T-5T-5T-5T-5T-5T-5T-5T-5T-5T-5T-2T-2T-2T-2T-2T-2T-2T-2T-2T-2T-2T-2T-2T-2T-2T-2T-2T-2T-2T-2T-6T-6T-6T-6T-6T-6T-6T-6T-6T-6T-2T-2T-2T-2T-2T-2T-2T-2T-2T-2T-2T-2T-2T-2T-2T-2T-2T-2T-2T-2T-7T-7T-7T-7T-7T-7T-7T-7T-7T-7T-2T-2T-2T-2T-2T-2T-2T-2T-2T-2T-2T-2T-2T-2T-2T-2T-2T-2T-2T-2T-8T-8T-8T-8T-8T-8T-8T-8T-8T-8T.” That is, the exemplary predetermined pattern signal has twenty 2Ts, ten 3Ts, twenty 2Ts, ten 4Ts, twenty 2Ts, ten 5Ts, twenty 2Ts, ten 6Ts, twenty 2Ts, ten 7Ts, twenty 2Ts, and ten 8Ts. Further, 2T duty, recording power PW, and bias power are used as variables to adjust the symmetric characteristics of the RF signals in the simulation. Here, the 2T duty is a reflection level adjustment value for a 2T recording mark or space.

Referring to FIG. 3, in a first case where the 2T duty varies from values of 0.40 to 0.30, and then to 0.50, and other conditions are fixed, the asymmetry of the RF signal obtained from the random pattern is similar to the asymmetry of the RF signal obtained from the predetermined pattern of the present invention. For example, the RF signal obtained from the random pattern has an asymmetry of 0.03 in row no. 1, and the RF signal obtained from the predetermined pattern of the present invention has a very similar asymmetry of 0.04 in row no. 2.

Further, where the recording power PW varies and other conditions are fixed, the asymmetry of the RF signal obtained from the random pattern is similar to the asymmetry of the RF signal obtained from the predetermined pattern of the present invention. For example, when the recording power PW is 9.60 mw, the bias power is 4.30 mV, and the 2T duty is 0.40, the RF signal obtained from the random pattern has an asymmetry of 0.10 in row no. 9, and the RF signal obtained from the predetermined pattern of the present invention has a very similar asymmetry of 0.10 in row no. 10. Furthermore, where the bias power varies and other conditions are fixed, the asymmetry of the RF signal obtained from the random pattern is similar to the asymmetry of the RF signal obtained from the predetermined pattern of the present invention.

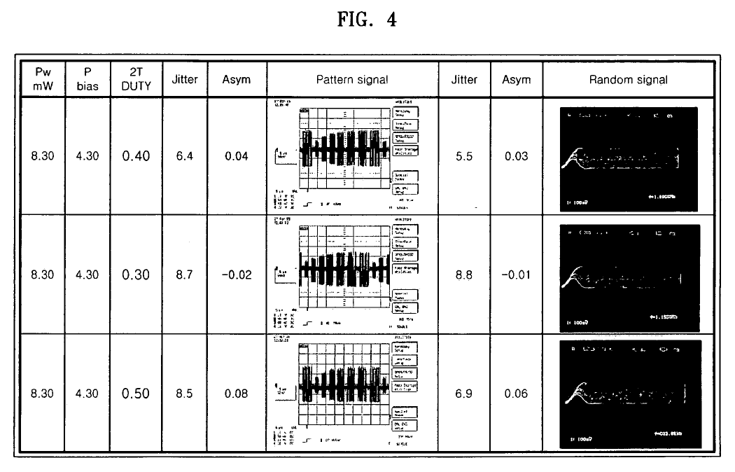

FIGS. 4 and 5 show simulation results obtained based on the conditions of FIG. 3. Referring to FIG. 4, where the 2T duty varies from 0.40 to 0.30, and then to 0.50, and other conditions are fixed, the asymmetry of the RF signal obtained from the predetermined pattern varies from 0.04 to −0.02, and then to 0.08. Further, in the same case, the asymmetry of the RF signal obtained from the random pattern varies from 0.03 to −0.01, and then to 0.06. That is, when only the 2T duty varies, the asymmetry of the RF signal due to the predetermined pattern is very similar to that of the RF signal due to the random pattern. Referring to FIG. 5, in another case where the 2T duty is fixed, and the recording power PW and the bias power vary, the asymmetry of the RF signal obtained from the predetermined pattern is similar to the asymmetry of the RF signal obtained from the random pattern of the present invention.

As is mentioned above, it may be understood that the asymmetry of the RF signal obtained from the predetermined pattern of this embodiment of the present invention is similar to that of the RF signal obtained from the random pattern.

Generally, asymmetry and modulation are used as indicators to represent the characteristics of an RF signal obtained from an information recording medium such as an optical disk. The asymmetry indicates how far the center of an RF signal obtained by a predetermined period that is shorter than the maximum period is from the center of an RF signal that is obtained by the maximum period. The modulation indicates how small the amplitude of the RF signal during the shorter period is when compared with the amplitude of the RF signal during the maximum period. For instance, if the maximum period is 8T, the asymmetry indicates how far the center of an RF signal that is obtained by a predetermined T that is shorter than the 8T period is from the center of an RF signal that is obtained by the 8T. Meanwhile, the modulation indicates how small the amplitude of the RF signal during the shorter T period is when compared with the amplitude of the RF signal during the 8T period. The asymmetry and modulation must be within a certain range in order to record/reproduce predetermined data on/from an information recording medium. As described above with reference to FIGS. 3 through 5, the RF signal by the predetermined pattern of the present invention has a similar asymmetry characteristic to the signal by the random pattern. Therefore, if the RF signal by the predetermined pattern of the present invention satisfies a reference asymmetry characteristic, the RF signal by the random pattern may satisfy the reference asymmetry characteristic.

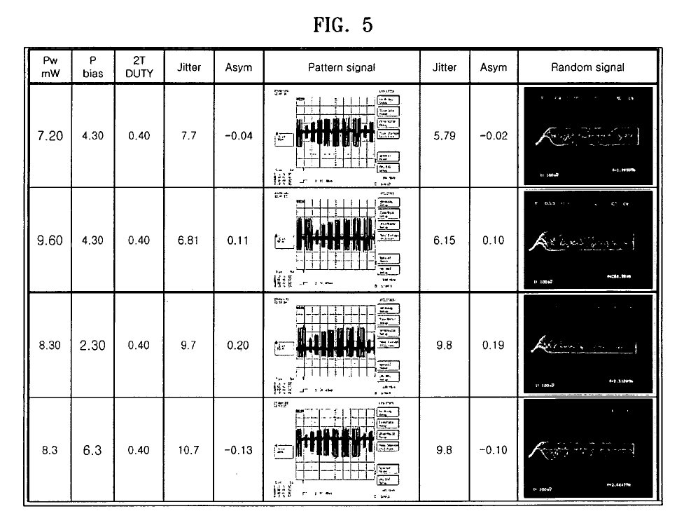

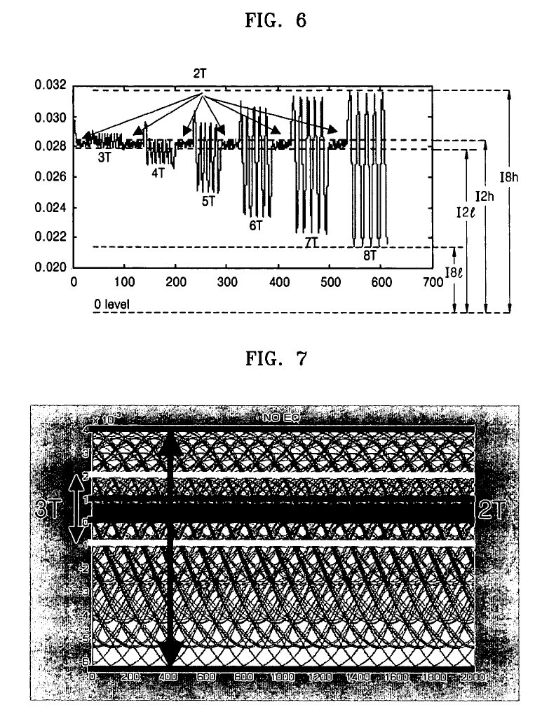

FIG. 6 is a graph showing an RF signal waveform detected from an information recording medium formed with a predetermined pattern according to an embodiment of the present invention, and FIG. 7 is a graph showing a Phase Loop Lock (PLL) signal prior to equalization (EQ) in an information recording medium with a predetermined pattern according an embodiment of to the present invention.

Referring to FIG. 6, the RF signal is relatively clearly detected by the predetermined pattern configured with a combination of marks or spaces having various lengths of 2T to 8T. In detail, the RF signal, which corresponds to the predetermined pattern configured with the combination of 2T through 8T, according to an embodiment of the present invention, is detected where the level of the RF signal is measurable for the respective Ts with respect to a reference level (0 level). Here, modulation level is the ratio of the amplitude (18h−18l) of the RF signal by the 8T to the amplitude (12h−12l) of the RF signal during the 2T. That is, the modulation level is the ratio of (18h−18l)/(12h−12l). Further, the asymmetry is expressed by the relationship {(18h+18l)/2−(12h−12l)/2}/(18h−18l). Referring to FIG. 7, it may be seen again that an RF signal corresponding to each T is detectable from an information recording medium having the predetermined pattern according to an embodiment of the present invention.

Characteristics of an RF signal that are detected from a super-resolution recording medium with a predetermined pattern according to an embodiment of the present invention will now be described.

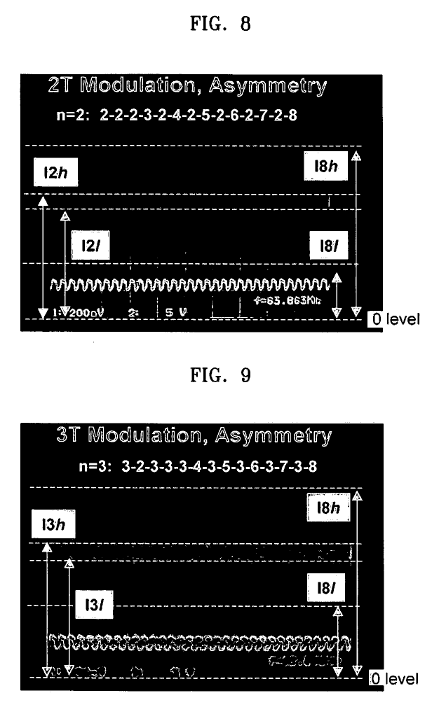

FIGS. 8 and 9 are graphs showing RF signal waveforms detected from predetermined pattern signals recorded on a super-resolution recording medium according to an embodiment of the present invention. Here, FIG. 8 shows an RF signal waveform detected when the predetermined pattern signal has a 2T-2T-2T-3T-2T-4T-2T-5T-2T-6T-2T-7T-2T-8T pattern, and FIG. 9 shows an RF signal waveform detected when the predetermined pattern signal has a 3T-2T-3T-3T-3T-4T-3T-5T-3T-6T-3T-7T-3T-8T pattern. In this experiment, a laser beam with a 405-nm wavelength and an object lens with a numerical aperture of 0.85 are used to detect the amplitude of the RF signal. Further, the shortest 2T mark of the predetermined pattern has a length of 75 nm. Here, the recording resolving power of the recording and/or reproducing apparatus that records and/or reproduces information to and/or from the super-resolution recording medium is 120 nm.

As shown in FIG. 8, an RF signal level corresponding to the 2T marks having a length shorter than the resolving power of the recording and/or reproducing apparatus that records and/or reproduces information to and/or from the information recording medium is detectable. Further, as shown in FIG. 9, an RF signal level corresponding to a 3T mark is detectable. That is, in the RF signal obtained from the predetermined pattern of the present invention, the RF signal level corresponding to a mark that is shorter than the resolving power of the recording and/or reproducing apparatus that records and/or reproduces information to and/or from the information recording medium and RF signal levels corresponding to respective Ts are detectable.

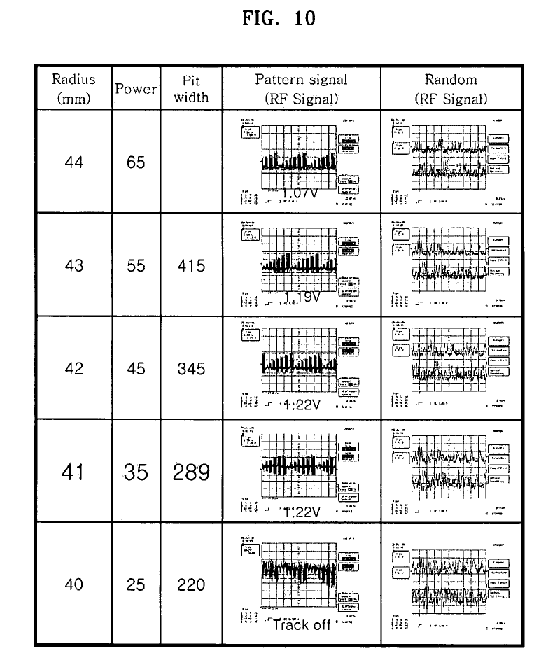

FIG. 10 provides a set of graphs showing RF signals detected from predetermined patterns and random patterns recorded on a super-resolution recording medium at predetermined recording power levels according to an embodiment of the present invention. Here, the predetermined pattern is that which is used in FIG. 3, and the 1-7 PLL code is used for the random pattern.

In FIG. 10, the term “radius” denotes the distance between the center of the super-resolution recording medium and each of the predetermined patterns and the random patterns formed on the super-resolution recording medium at different recording power levels. That is, after the predetermined patterns and the random patterns are formed on the super-resolution recording medium in a radial range of 40 to 44 mm at different recording power levels, the RF signals obtained from the predetermined patterns and the random patterns are observed.

Referring to FIG. 10, as the recording power increases, an RF signal level corresponding to a T having short length is lowered in the RF signal obtained from the predetermined pattern of the present invention and the overall asymmetry characteristic is also degraded. Further, it is shown that the RF signal obtained from the predetermined pattern has the best relative asymmetry characteristic when the recording power is 35 mw. Particularly, as the RF signal level of the RF signal obtained from the predetermined pattern of the present invention varies, the RF signal level of the random pattern RF signal varies as well.

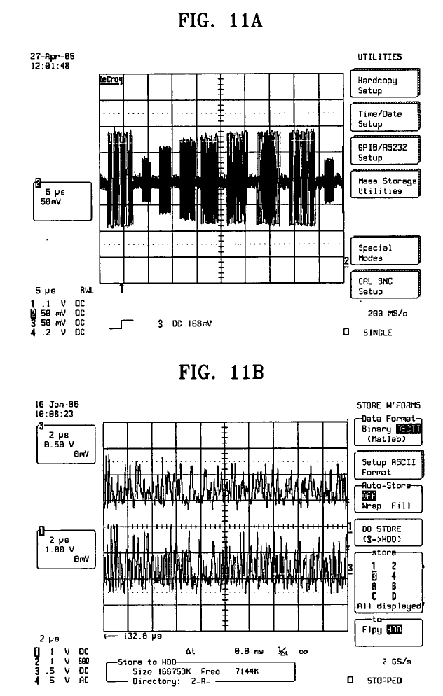

FIGS. 11A through 12C are graphs showing the RF signals depicted in FIG. 10. Here, FIG. 11A is a graph showing an RF signal reproduced using a predetermined pattern recorded at a radius of 41 mm and a recording power of 35 mw shown in FIG. 10, FIG. 11B is a graph showing an RF signal reproduced using a random pattern recorded at the same condition, and FIG. 11C is the graph shown in FIG. 11b at an enlarged time scale. FIG. 12A is a graph showing an RF signal reproduced using a predetermined pattern recorded at a radius of 44 mm and a recording power of 65 mw shown in FIG. 10, FIG. 12B is a graph showing an RF signal reproduced using a random pattern recorded at the same condition, and FIG. 12C is the graph shown in FIG. 11B at an enlarged time scale.

Referring to FIGS. 11A through 11C, if the RF signal reproduced using the predetermined pattern of the present invention maintains a symmetry, that is, if the RF signal reproduced using the predetermined pattern exhibits a good asymmetry characteristic, the RF signal reproduced using the random pattern is also detected normally without distortion as shown in portion A of FIG. 11C. However, referring to FIGS. 12A through 12C, the RF signal reproduced using the predetermined pattern of the present invention has a bad asymmetry characteristic, and the level of the RF signal corresponding to 2T is lowered. In this case, the entire level of the RF signal reproduced using the random pattern is also lowered and the RF signal is saturated, causing signal distortion and lowering modulation. In other words, if the RF signal reproduced using the predetermined pattern exhibits a good asymmetry characteristic, the RF signal reproduced using the random pattern also exhibits a good asymmetry characteristic; however, if the RF signal reproduced using the predetermined pattern of the present invention has a bad asymmetry characteristic, the RF signal reproduced using the random signal is distorted much more.

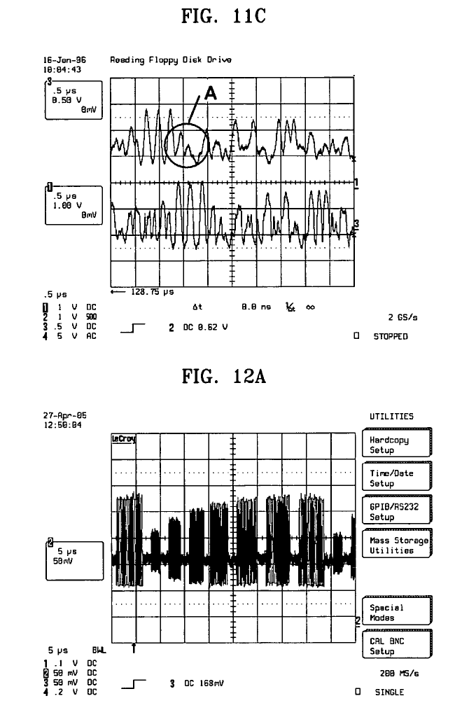

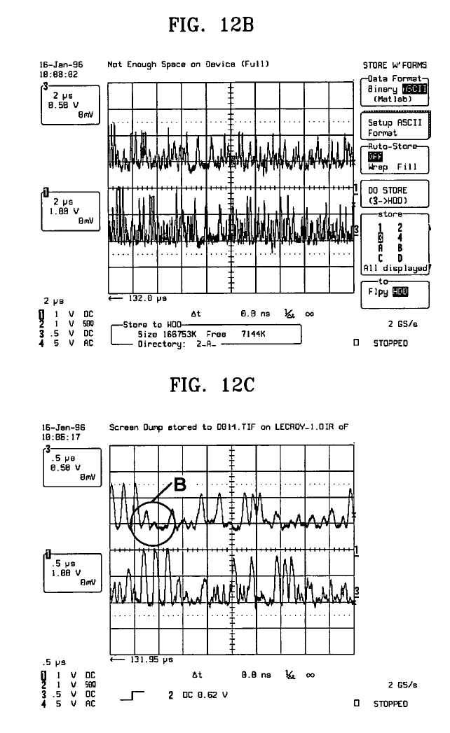

FIG. 13 is a graph showing RF signal waveforms detected from random patterns recorded under the conditions of a 44-mm radius and a 65-mw recording power, and under the conditions of a 41-mm radius and 35-mw recording power, from among the conditions in FIG. 10, and FIGS. 14A and 14B are graphs showing RF signals detected from predetermined patterns recorded under the conditions of a 44-mm radius and a 65-mw recording power, and under the conditions of a 41-mm radius and 35-mw recording power according to an embodiment of the present invention.

If the RF signal reproduced using the predetermined pattern that is recorded at the radius of 41 mm exhibits a stable asymmetry characteristic as shown in FIG. 14B, a level corresponding to the longest period T is lower than other levels corresponding to other periods T in the RF signal (see 1320 in FIG. 13) reproduced using the random pattern, thereby allowing a stable sync detection. However, if the RF signal reproduced using the predetermined pattern recorded at the radius of 44 mm exhibits an unstable asymmetry characteristic as shown in FIG. 14A, other levels corresponding to other periods T are lower than the level corresponding to the longest period T in the RF signal (see 1310 in FIG. 13) reproduced using the random pattern recorded under the same conditions as shown in portions C in FIG. 13, thereby causing an unstable sync detection.

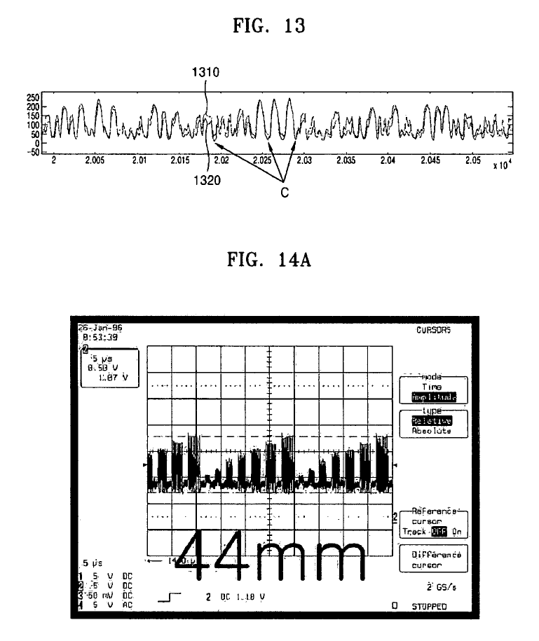

FIG. 15 shows simulation results of bit error rates (BER) based on the asymmetry characteristic of the predetermined pattern signal according to an embodiment of the present invention.

Referring to FIG. 15, as described above, in the region where the recording power is high, that is, where the RF signal that is obtained from the predetermined pattern of the present invention has a bad asymmetry characteristic, the sync detection cannot be performed. Thus, BER decoding is poorly performed. On the contrary, if the RF signal obtained from the predetermined pattern of the present invention has a good asymmetry characteristic, as in the case where the predetermined pattern is recorded at a recording power of 35 mW and a radius of 41 mm, an RF signal obtained from a random pattern signal recorded under the same recording conditions as the predetermined pattern has the lowest BER. In other words, if the RF signal obtained from the predetermined pattern of the present invention has a good asymmetry characteristic, the RF signal obtained from the random pattern recorded under the same recording conditions as the predetermined pattern has a reduced error rate. Here, as the RF signal obtained from the predetermined pattern has a better asymmetry characteristic, the RF signal obtained from the random pattern has a smaller error rate. Therefore, the RF signal obtained using the predetermined pattern is closely related with the RF signal obtained using the random pattern.

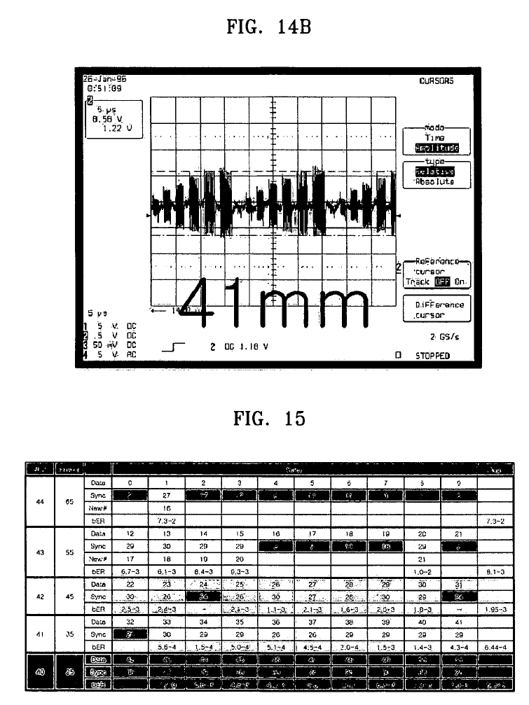

FIG. 16 is a graph showing BER with respect to asymmetry and 2T modulation in the predetermined pattern of the present invention. In FIG. 16, the x-axis represents the asymmetry and 2T modulation of the RF signal obtained using the predetermined signal according to an embodiment of the present invention, and the y-axis represents the BER of an RF signal obtained using a random pattern formed under the same recording condition as the predetermined pattern.

Referring to FIG. 16, the RF signal obtained using the predetermined pattern exhibits the lowest relative asymmetry value of 8% at specific recording conditions of the predetermined pattern, and the RF signal obtained using the random pattern exhibits the best relative BER (refer to point D in FIG. 16) when the random pattern is formed under the same specific recording conditions as the predetermined pattern. Further, as the asymmetry or the modulation of the RF signal obtained using the predetermined pattern increases, the BER of the RF signal obtained using the random pattern worsens. Merely, the BER varies depending on the asymmetry more than the modulation.

As is described above, where extracting signal levels from a signal due to ISI is difficult, the predetermined pattern is used to extract each signal level (T). In this way, the factors directly influencing the quality (BER) of the signal are determined so that the quality of the RF signal may be improved. Further, the level of each T signal obtained from a random pattern formed on an information recording medium may be determined by detecting the level of an RF signal obtained from the predetermined pattern formed on the information recording medium.

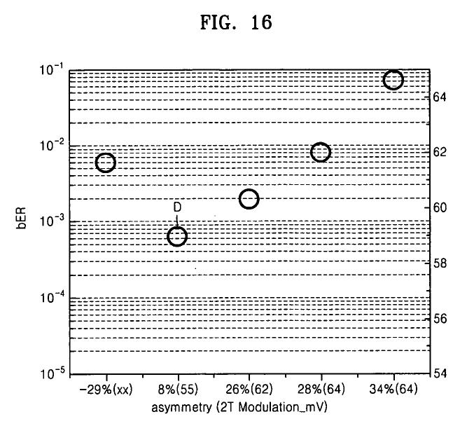

FIG. 17 is a flowchart showing a method of determining an optimal recording condition according to an embodiment of the present invention. As shown in FIG. 17, in operation 1710, a predetermined pattern signal is recorded on an information recording medium while a recording condition is varied. As is described above, for detecting levels of an RF signal, the predetermined pattern signal may be configured with periodically repeating nT pulses and mT pulses intervening between the nT pulses, where n denotes a natural number, T denotes a clock period, and m denotes values corresponding to respective levels of an RF signal to be detected using the predetermined pattern. Further, recording power, bias power, or 2T duty may be used as the recording condition.

In operation 1720, a level variation is detected from an RF signal reproduced from the predetermined pattern signal.

In operation 1730, whether the level of the RF signal reproduced from the predetermined pattern signal satisfies a predetermined reference condition is determined. As is described above, if the RF signal reproduced using the predetermined pattern signal has relatively good asymmetry and/or modulation amplitude characteristics, an RF signal reproduced from a random pattern also has relatively good characteristics. Therefore, when the RF signal obtained using the predetermined pattern signal has a quality that is higher than a predetermined level, the recording condition of the predetermined pattern is selected as a recording condition for recording random data.

If the RF signal that is reproduced from the predetermined pattern signal does not satisfy the predetermined reference condition, the recording condition such as the recording power, the bias power, and the 2T duty is adjusted in operation 1740. Operations 1710 through 1730 are then repeated.

If the RF signal reproduced from the predetermined pattern signal satisfies the predetermined reference condition, the recording condition used for recording the predetermined pattern signal is selected as an optimal recording condition for recording arbitrary random data in operation 1750.

Meanwhile, when information recording media such as super-resolution recording media are manufactured, the selected optimal recording condition may be stored in the information recording medium in a predetermined information recording zone.

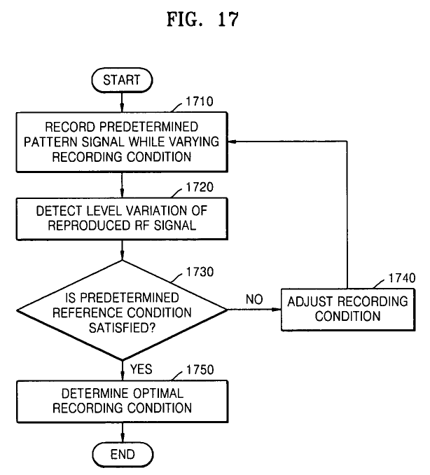

FIG. 18 shows a configuration of an information recording medium according to an embodiment of the present invention. As shown in FIG. 18, when the information recording medium is manufactured, the selected optimal recording condition may be stored in the information recording medium in a predetermined zone. That is, when the information recording medium is manufactured, the optimal recording condition may be stored in the information recording medium in a predetermined zone as a reference signal to calculate a recording condition such as a recording power. The reference signal is previously recordable on the information recording medium using a ROM pit, a pre-recorded mark, or a wobble.

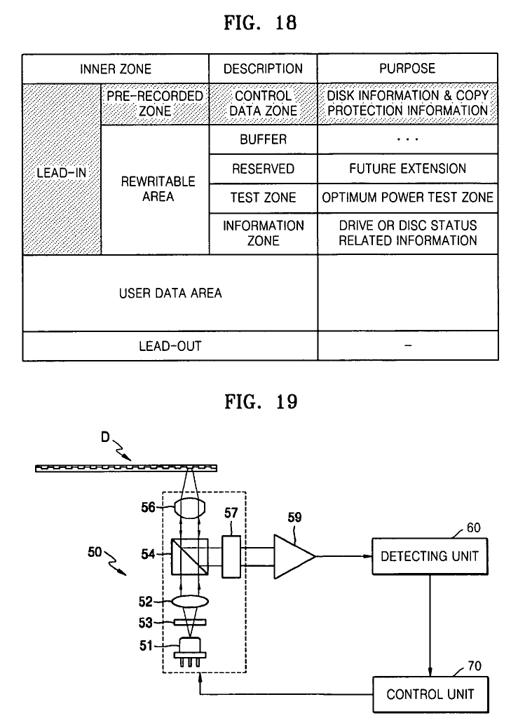

FIG. 19 shows a recording and/or reproducing apparatus using an information recording medium according to an embodiment of the present invention. As shown in FIG. 19, the recording/reproducing apparatus includes a pick-up unit 50, a level detecting unit 60, and a control unit 70. The pick-up unit 50 includes a laser diode 51 to emit light, a collimating lens 52 to collimate the light from the laser diode 51, a beam splitter 54 to change the direction of incident light, and an object lens 56 to condense the light transmitted through the beam splitter 54 onto an information recording medium (D). The pick-up unit 50 projects a recording beam onto the information recording medium (D) to record a predetermined pattern signal according to an embodiment of the present invention and also projects a reproducing beam to the information recording medium to receive a reflected optical signal.

The reflected optical signal from the information recording medium (D) is reflected by the beam splitter 54 to an optical detector 57. Here, the optical detector 57 may be a quadrant optical detector. The optical signal that reaches the optical detector 57 is converted into an electrical signal and is outputted as an RF signal through the operation circuit 59.

The level detecting unit 60 detects level variation in the RF signal and outputs the result of the detection to the control unit 70. The control unit 70 determines whether the RF signal satisfies a predetermined reference condition using the level variation of the RF signal detected from the level detecting unit 60. If the RF signal satisfies the predetermined reference condition, a recording condition such as recording power, bias power, and 2T duty used to record the predetermined pattern signal is selected as an optimal recording condition. That is, the control unit 70 observes the variation of the RF signal to determine the optical recording condition when the level of the RF signal has an optimal symmetric state.

If the RF signal does not satisfy the predetermined reference condition, the control unit 70 controls the pick-up unit 50 to record the predetermined pattern signal using a different recording condition. Meanwhile, if information regarding the optimal recording condition is previously recorded in the information recording medium at a predetermined zone, the pick-up unit 50 reads the information related to the optimal recording condition, and the control unit 70 detects the level of the RF signal reproduced using the predetermined pattern signal, so that each T signal level and recording conditions may be determined.

As is described above, according to aspects of the present invention, levels of respective T signals are detectable even when detection of the level of the RF signal is difficult due to inter symbolic interference (ISI) in the super-resolution recording medium having marks smaller than the resolving power of the recording and/or reproducing apparatus that records and/or reproduces information to and/or from the information recording medium.

Further, according to aspects of the present invention, the optimal recording condition of the information recording medium may be easily determined using the predetermined pattern signal, and factors directly related to BER may be determined to improve the RF signal quality.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information recording medium for use with a recording apparatus that records information to the information recording medium on which a predetermined pattern is recorded to generate a predetermined pattern signal with periodically repeating nT pulses and intervening mT pulses to allow for a detection of levels of an RF signal when the recording apparatus reads the information from the information recording medium, where n denotes a natural number, T denotes a clock period, and m denotes values corresponding to the respective levels of the RF signal.

2. The information recording medium of claim 1, wherein the predetermined pattern is recorded using one of a ROM pit, a pre-recorded mark, and a wobble.

3. The information recording medium of claim 1, wherein the nT is shorter than a resolving power of the recording apparatus and the mT is equal to or longer than the resolving power of the recording apparatus.

4. The information recording medium of claim 1, wherein the nT is 2T or 3T, and the mT is one of 3T, 4T, 5T, 6T, 7T, and 8T.

5. A method of operating a recording apparatus to determine an optimal recording condition of an information recording medium, comprising:
recording a predetermined pattern on the information recording medium while changing a recording condition, the predetermined pattern being configured such that a predetermined pattern signal generated from a reading of the predetermined pattern includes periodically repeating nT pulses and intervening mT pulses, where n denotes a natural number, T denotes a clock period, and m denotes values corresponding to respective levels of an RF signal to be detected using the predetermined pattern signal;
detecting the levels of the RF signal corresponding to the predetermined pattern signal; and
when the detected levels of the RF signal satisfy a predetermined reference condition, setting a corresponding recording condition as the optimal recording condition.

6. The method of claim 5, wherein the predetermined pattern is recorded using one of a ROM pit, a pre-recorded mark, and a wobble.

7. The method of claim 5, wherein the nT is shorter than a resolving power of the recording apparatus and the mT is equal to or longer than the resolving power of the recording apparatus.

8. The method of claim 5, wherein the nT is 2T or 3T, and the mT is one of 3T, 4T, 5T, 6T, 7T, and 8T.

9. The method of claim 5, wherein the recording condition is at least one of 2T duty, a recording power of the recording apparatus, and a bias power of the recording apparatus.

10. The method of claim 5, wherein the predetermined reference condition is set using asymmetry and/or modulation amplitude of the RF signal.

11. The method of claim 5, further comprising recording the determined optimal recording condition in a lead-in zone and/or lead-out zone of the information recording medium.

12. A recording and/or reproducing apparatus to record and/or reproduce information to an information recording medium, comprising:
a pick-up unit to record a predetermined pattern on the information recording medium while changing a recording condition, the predetermined pattern being configured to generate a predetermined pattern signal being including periodically repeating nT pulses and intervening mT pulses, where n denotes a natural number, T denotes a clock period, and m denotes values corresponding to respective levels of an RF signal to be detected using the predetermined pattern signal;
a detecting unit to detect the levels of the RF signal corresponding to the predetermined pattern signal, the RF signal being read from the information recording medium; and
a control unit to determine a corresponding recording condition as the optimal recording condition when the detected levels of the RF signal satisfy a predetermined reference condition.

13. The apparatus of claim 12, wherein the predetermined pattern is recorded using one of a ROM pit, a pre-recorded mark, and a wobble.

14. The apparatus of claim 12, wherein the nT is shorter than a resolving power of the recording/reproducing apparatus and the mT is equal to or longer than the resolving power of the recording/reproducing apparatus.

15. The apparatus of claim 12, wherein the nT is 2T or 3T, and the mT is one of 3T, 4T, 5T, 6T, 7T, and 8T.

16. The apparatus of claim 12, wherein the recording condition is at least one of 2T duty, a recording power of the apparatus, and a bias power of the apparatus.

17. The apparatus of claim 12, wherein the predetermined reference condition is set using asymmetry and/or modulation amplitude of the RF signal.

18. The apparatus of claim 12, wherein the pick-up unit records the determined optimal recording condition in a lead-in zone and/or lead-out zone of the information recording medium.

19. A method of operating a recording apparatus that records information to an information storage medium on which a predetermined pattern is recorded, the predetermined pattern being configured to generate a predetermined signal, including periodically repeating nT pulses and intervening mT pulses, where n denotes a natural number, T denotes a clock period, and m denotes values corresponding to respective levels of a Radio Frequency (RF) signal associated with the predetermined signal, when the recording apparatus records the information, the method comprising:
recording the predetermined pattern signal while varying a recording condition;
detecting a variation of a level of the RF signal due to the varied recording condition;
determining whether a predetermined reference condition related to the level of the RF signal is satisfied;
adjusting the recording condition, if the predetermined reference condition is not found to be satisfied, and repeating the recording, detecting, and determining operations until the predetermined reference condition is found to be satisfied; and
determining that the recording condition is optimal if the predetermined reference condition is satisfied.

20. A computer readable medium on which a program is stored to execute the method of claim 19.

21. An information reproducing medium for use with a reproducing apparatus that reproduce information from the information reproducing medium on which a predetermined pattern is recorded to generate a predetermined pattern signal with periodically repeating nT pulses and intervening mT pulses to allow for a detection of levels of an RF signal when the reproducing apparatus reads the information from the information reproducing medium, where n denotes a natural number, T denotes a clock period, and m denotes values corresponding to the respective levels of the RF signal.

22. The information reproducing medium of claim 21, wherein the nT is 2T or 3T, and the mT is one of 3T, 4T, 5T, 6T, 7T, and 8T.

23. A method of operating a reproducing apparatus to determine an optimal reproducing condition of an information reproducing medium, comprising:
reproducing a predetermined pattern on the information reproducing medium while changing a reproducing condition, the predetermined pattern being configured such that a predetermined pattern signal generated from a reading of the predetermined pattern includes periodically repeating nT pulses and intervening mT pulses, where n denotes a natural number, T denotes a clock period, and m denotes values corresponding to respective levels of an RF signal to be detected using the predetermined pattern signal;
detecting the levels of the RF signal corresponding to the predetermined pattern signal; and
when the detected levels of the RF signal satisfy a predetermined reference condition, setting a corresponding reproducing condition as the optimal reproducing condition.

24. The method of claim 23, wherein the nT is 2T or 3T, and the mT is one of 3T, 4T, 5T, 6T, 7T, and 8T.

25. The method of claim 23, wherein the predetermined reference condition is set using asymmetry and/or modulation amplitude of the RF signal.
